(19) United States
(12) Patent Application Publication
(10) Pub. No.: US 2012/0249448 A1
(43) Pub. Date: Oct. 4, 2012

(54) METHOD OF IDENTIFYING A GESTURE AND DEVICE USING THE SAME

(75) Inventors: Xiaoning LIU, Shenzhen (CN); Tiejun Cai, Shenzhen (CN); Tingting Liu, Shenzhen (CN); Bangjun He, Shenzhen (CN); Yun Yang, Shenzhen (CN)

(73) Assignee: BYD COMPANY LIMITED, Shenzhen (CN)

(21) Appl. No.: 13/355,307

(22) Filed: Jan. 20, 2012

(30) Foreign Application Priority Data
Mar. 31, 2011 (CN) 201110081232.0

(51) Int. Cl. G06F 3/041

(52) U.S. Cl. 345/173

(57) ABSTRACT

A method of identifying gestures on a touchpad comprises determining a first time interval between receipt and drop in a first contact signal induced by a first contact with the touchpad, recording a first start touch point and a first end touch point associated with the receipt and drop in the first contact signal, determining a gesture according to the first time interval, the first start touch point and the first end touch point and generating a control signal associated with the determined gesture.

### CROSS-REFERENCE TO RELATED APPLICATION

This application claims priority under 35 U.S.C. §119 to Chinese Patent Application No. 201110081232.0, filed on Mar. 31, 2011, the content of which is incorporated herein by reference in its entirety.

### TECHNICAL FIELD

Example embodiments of the present disclosure relate generally to a identifying method, and more particularly, to a method of identifying a touch gesture and device thereof.

### BACKGROUND

Although the keyboard remains a primary input device of a computer, the prevalence of graphical user interfaces (GUIs) may require use of a mouse or other pointing device such as a trackball, joystick, touchpad or the like. Operations performed by the pointing devices generally correspond to moving a cursor, making selections, dragging, zoom in/out, rotating or the like.

Touchpads are commonly used on portable electronic devices by providing a panel for user's fingers or other conductive objects to touch or move thereon. Operations on touchpads may be implemented by detecting hand gestures. For example, selections may be made when one or more taps are detected on the touchpads. In addition to selections, moving a selected content from one place to another may be made by dragging a user's finger across the touchpad.

### SUMMARY

According to one exemplary embodiment of the present invention, a method of identifying gestures on a touchpad comprises determining a first time interval between receipt and drop in a first contact signal induced by a first contact with the touchpad, recording a first start touch point and a first end touch point associated with the receipt and drop in the first contact signal, determining a gesture according to the first time interval, the first start touch point and the first end touch point and generating a control signal associated with the determined gesture.

According to one exemplary embodiment of the present invention, a touch gesture identifying device comprises a touch screen, an identifying module and a data storage medium. The touch screen is configured to receive a first contact signal induced by a first contact with the touchpad. The identifying is configured to determine a first time interval between receipt and drop in the first contact signal, record a first start touch point associated with receipt of the first contact signal and a first end touch point associated with drop in the first contact signal, and determine a gesture according to the first time interval, the first start touch point and the first end touch point. The data storage medium is configured to store data output from the touch screen and the identifying module.

### BRIEF DESCRIPTION OF THE DRAWINGS

Having thus described example embodiments of the present disclosure in general terms, reference will now be made to the accompanying drawings, which are not necessarily drawn to scale, and wherein:

FIG. 1 illustrates a block diagram of a touch gesture identifying device according to exemplary embodiments of the present invention;

FIG. 2 illustrates a block diagram of a touch gesture identifying device according to exemplary embodiments of the present invention;

FIG. 3 is a flow chart describing a method for detecting gestures on a touchpad device according to one exemplary embodiment of the present invention;

FIG. 4 illustrates diagrams of detected signals and a single click signal on a touchpad device according to one exemplary embodiment of the present invention;

FIG. 5 illustrates diagrams of detected signals and a double click signal on a touchpad device according to one exemplary embodiment of the present invention; and

FIG. 6 illustrates diagrams of detected signals and a drag signal on a touchpad device according to one exemplary embodiment of the present invention.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

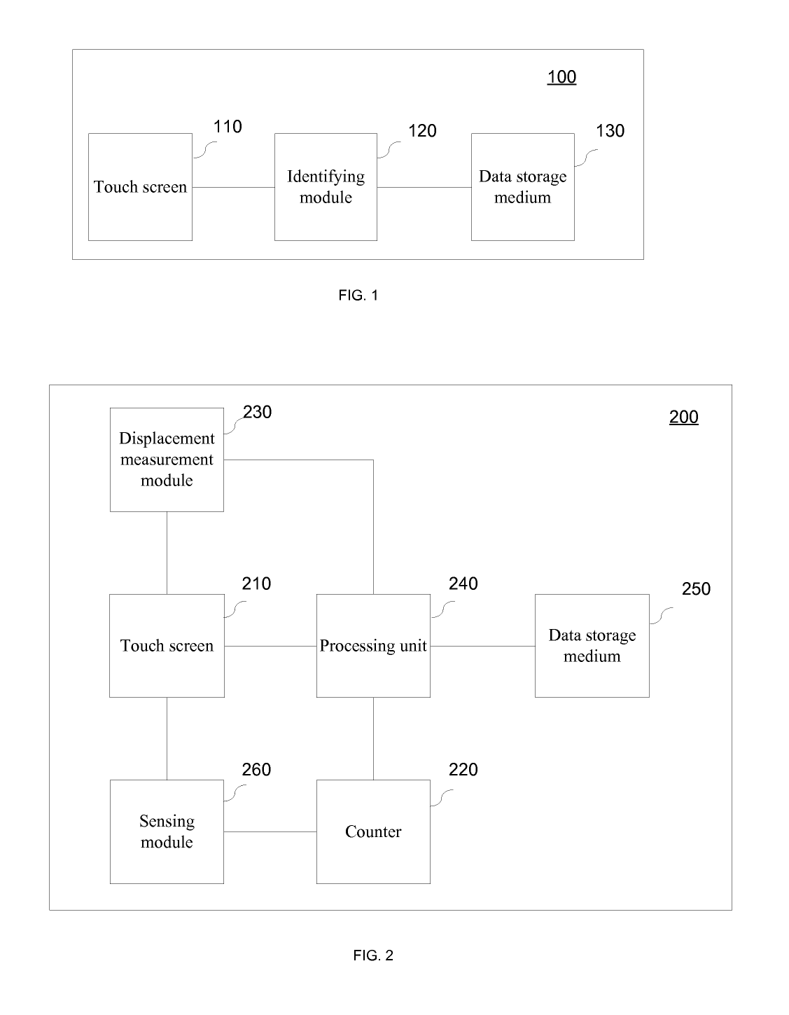

FIG. 1 illustrates a schematic diagram of a touch gesture identifying device 100 according to an exemplary embodiment of the present invention (“exemplary” as used herein referring to “serving as an example, instance or illustration”). The touch gesture identifying device 100 may comprise a touch screen 110, an identifying module 120 and a data storage medium 130. When a user's finger is resting on the touch screen 110, the contact with the touch screen 110 may be sensed by a sensing unit (not numbered) embedded in the identifying module 120, which may be embodied in a number of different manners, such as in the form of a resistive touch screen, a capacitive touch screen, an infrared touch screen, an optical imaging touch screen, an acoustic pulse touch screen, surface acoustic touch screen or in any other forms.

The identifying module 120 may include a processing unit (not numbered) that is configured to determine time intervals between receipt and drop in one or two contact signals. The receipt and the drop signal may be associated with two subsequent contact signals. The identification module 120 may be configured to identify coordinates of each touch point on the touch screen 110 and calculate displacement between a start touch point associated with receipt of a contact signal and an end touch point associated with a drop signal. The start touch point and the end touch point may be associated with two subsequent contact signals. The identifying module 120 may be configured to determine a gesture and generate corresponding control signals based on coordinates of touch points on the touch screen 110. The processing unit may be configured to provide the control signals and other related information to a terminal application device to execute the gesture applied to the touch screen. The terminal application device may be any of a number of different processing devices including, for example, a laptop computer, desktop computer, server computer, or a portable electronic devices such as a portable music player, mobile telephone, portable digital assistant (PDA), tablet or the like. Generally, the terminal application device may include the processing unit, memory, user interface (e.g., display and/or user input interface) and/or one or more communication interfaces. As will be appreciated, the identifying module 120 may include a counter embodied in the form of a software program or an electronic circuit, e.g., a cyclic counter. In various embodiments, the counter may be reset on receipt and/or drop in a contact signal.

The identifying module 120 is configured to communicate with the data storage medium 130. The data storage medium 130 may be volatile memory and/or non-volatile memory, which may store data received or calculated by the processing unit, and may also store one or more software applications, instructions or the like for the identifying module 120 to perform functions associated with operation of the device in accordance with exemplary embodiments of the present invention.

FIG. 2 illustrates a schematic diagram of touch gesture identifying device 200 according to an exemplary embodiment of the present invention. The identification device includes a touch screen 210, a counter 220, a displacement measurement module 230, a processing unit 240, and a data storage medium 250 and a sensing module 260. When the touch screen 210 is powered on, the counter 220 starts to count. The counter 220 may be reset and restart in presence or absence of a contact on the touch screen 210. When a user's finger is resting on the touch screen 210, the contact with the touch screen 210 may be sensed by the sensing module 260, which may be embodied in a number of different manners, such as in the form of a resistive touch screen, a capacitive touch screen, an infrared touch screen, an optical imaging touch screen, an acoustic pulse touch screen, surface acoustic touch screen or in any other forms.

The displacement measurement module 230 is configured to record start touch point and end touch point of each contact that is presented on the touch screen 210 and measure the displacement between the start touch point and the end touch point. The start touch point and the end touch point may be associated with two subsequent contact signals.

The processing unit 240 may be configured to record time intervals between receipts of two adjacent signals, calculate reference intervals according to the displacements and the time intervals, and perform comparison functions to compare the reference intervals to predefined references. The processing unit 240 may be embodied in hardware in a number of different manners, such as a CPU (Central Processing Unit), microprocessor, coprocessor, controller and/or various other processing devices including integrated circuits such as ASIC (Application Specification Integrated Circuit), FPGA (Field Programmable Gate Array) or the like. The processing unit 240 may communicate with the data storage medium 250. The data storage medium 250 may be in a form of volatile memory, non-volatile memory or in any other forms, which may store data recorded or calculated by displacement measurement module 230 and the processing unit 240, and may also store predefined references, and one or more software applications, instructions or the like for the processing unit 240 to perform associated with operation of the device in accordance with exemplary embodiments of the present invention.

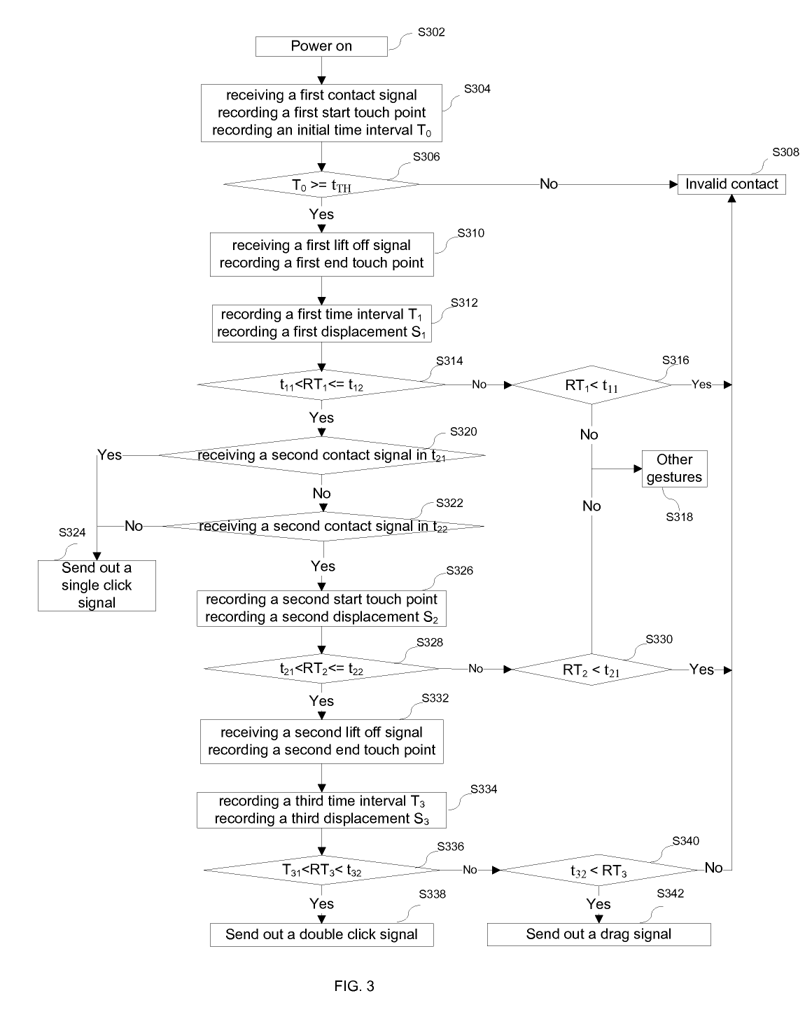

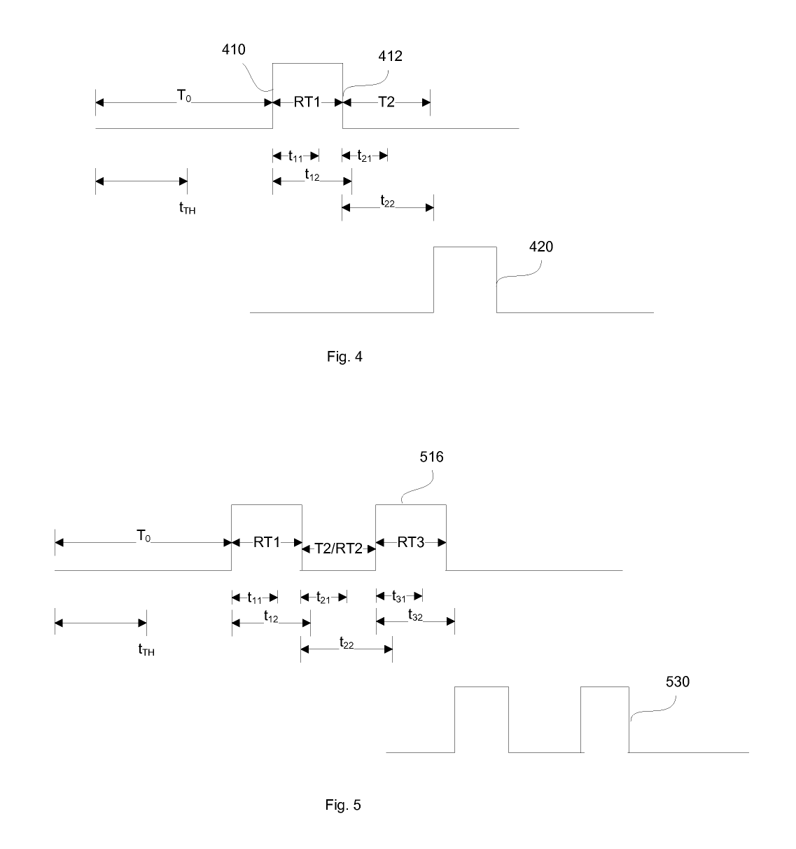

FIG. 3 is a flow chart describing a method for detecting gestures on a touchpad device according to one exemplary embodiment of the present invention. The flowchart will be described with reference to FIGS. 2, 4-6. The detecting method may start when the touchpad is powered on at step S302. The counter 220 may be reset or may start to count at this step. At step S304, the touchpad may receive a first contact signal 410 as shown in FIG. 4, at a time in which the counter 220 has a value T₀, which is referred as an initial time interval T₀. The initial time interval T₀ is recorded by the processing unit 240. The first contact signal may be caused by electronic noise, or may be induced by a user's contact. To prevent an unintentional contact on the touchpad from causing performance of erratic operations (e.g., cursor movement), the processing unit 240 embedded in or otherwise in communication with the touchpad may perform comparison functions to compare the initial time interval T₀ to a predefined threshold reference t_{TH} at step S306. In an instance in which T₀ is less than the predefined threshold reference t_{TH}, the processing unit 240 may determine that the first contact signal is an invalid signal at step S308. The touchpad will be then awaiting another contact to induce a corresponding contact signal. In an instance in which T₀ is larger than the predefined threshold reference t_{TH} at step S308, the counter 220 may continue to run, indicating that the user's finger may remain in contact with the touchpad, until the first valid contact signal ceases when the user lifts his/her finger off the touchpad, producing a drop (412 shown in FIG. 4) in the first valid contact signal at step S310. The processing unit 240 may record a first time interval T₁ corresponding to amount of time the first valid contact signal is received (the amount of time the user's finger remains in contact with the touchpad). A first start touch point associated with the first contact signal and a first end touch point associated with the first drop may be recorded by the displacement measurement module 230 at steps S304 or S310. A first displacement S₁ between the first start touch point and the first end touch point is accordingly recorded at step S312.

The processing unit 240 may calculate a first reference interval RT₁ and compare the first reference interval RT₁ to a first reference t₁₁ and a second reference t₁₂ at step S314 to determine if the first reference interval RT₁ is greater than the first reference t₁₁ and less than the second reference t₁₂. The first reference interval RT₁ may be the result of T₁₁×(S₁+1), the sum of T₁+S₁ or the result of other equations including parameters T₁ and/or S₁. The first reference interval RT₁ that is greater than the first reference t₁₁ and less than the second reference t₁₂ may indicate that a valid touch or a real touch is detected. In an instance in which the comparison result obtained at step S314 indicates that the first reference interval RT₁ is less than the first reference t₁₁ or larger than the second reference t₁₂, the method proceed to step S316. In an instance in which the first reference interval RT₁ is determined to be less than the first reference t₁₁ at step S316, the processing unit 240 may determine that the first contact is an invalid contact at step S308. Otherwise, the processing unit 240 may determine the contact is other gestures at step S318.

After the user lifts his/her finger off the touchpad, the counter 220 may be reset or may continue to run. The sensing module 260 may monitor for receipt of a second contact signal from the touchpad.

In an instance in which the touchpad receives a second contact signal at step S320, a second time interval T₂ is recorded as the time between the time the first valid signal ceased and receipt of the second contact signal. In an instance in which the second contact signal is received in the third reference time t₂₁, a single-click signal may be generated by the processing unit 240 and is output at step S324. In an instance in which the touchpad does not receive a second contact signal in a fourth reference time t₂₂ at step S322, a single-click signal may be generated by the processing unit 240 and is output at step S324.

In an instance in which the processing unit 240 receives a second contact signal 516 in a period that is greater than the third reference time t₂₁ but less than the fourth reference time t₂₂ (t₂₁<T₂≦t₂₂), as shown in FIG. 5, the displacement measurement module 230 records a second displacement S₂ as the displacement between the first end touch point associated with the first contact signal and a second start touch point associated with the second contact signal at step S326. The processing unit 240 then compares a second reference interval RT₂ to the third reference t₂₁ and the fourth reference time t₂₂, at step S328. The second reference interval RT₂ may be the result of T₂×(S₂+1), the sum of T₂+S₂ or the result of other equations including parameters T₂ and/or S₂. In an instance in which the second reference interval RT₂ is less than the third reference t₂₁ or larger than the fourth reference t₂₁ at step S328, the method proceeds to step S330. In an instance in which the second reference interval RT₂ is less than the third reference t₂₁ at step S330, the signal is determined as an invalid signal. The procedure proceeds to step S308. In an instance in which the second reference interval RT₂ is larger than the fourth reference t₂₂, the method goes to step S318 to determine that the detected second contact signal may be induced by other gestures.

In an instance in which the second time interval T₂ is greater than the third reference t₂₁ and less than the fourth reference t₂₂ at step S328, the sensing module 260 may monitor the second contact signal for a drop in the signal at step S332. On detecting a drop in the second contact signal by the sensing module 260, a third time interval T₃ and a displacement S₃ are respectively recorded by the processing unit 240 and the displacement measurement module 230 at step S334. The processing unit 240 then calculates a third time interval T₃ and compares the third time interval T₃ to a fifth reference t₃₁ and a six reference t₃₂ at step S336. The third time interval T₃ is recorded between receipt and drop in the second contact signal induced by the user's finger on the touchpad. The third displacement S₃ is recorded between the second start touch point and a second end touch point associated with the second contact signal. The processing unit 240 may compare a third reference interval RT₃ to the fifth reference t₃₁ and the sixth reference t₃₂. The third reference interval RT₃ may be the result of T₃×(S₃+1), the sum of T₃+S₃ or the result of other equations including parameters T₃ and/or S₃. In an instance in which the third time interval T₃ is greater than the fifth reference t₃₁, and less than the sixth reference t₃₂ at step S336, a double-click signal 530, as shown in FIG. 5, is generated by the processing unit 240 and is output at step S338.

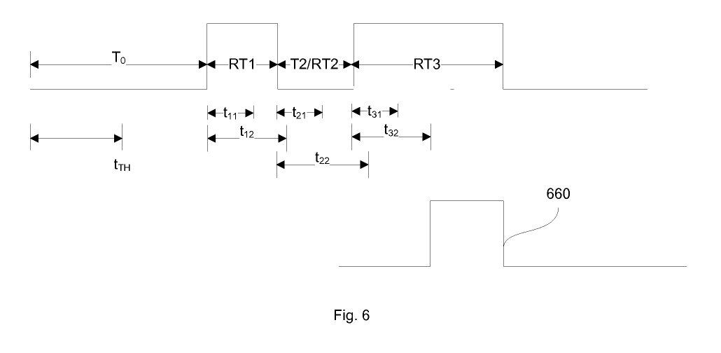

In an instance in which the third reference interval RT₃ is larger than the sixth reference t₃₂ at step S340, as shown in FIG. 6, a drag signal 660 is output at step S342. Otherwise, the second signal is determined as an invalid signal and the method goes to step S308.

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this invention is not limited to the particular examples disclosed, but it is intended to cover modifications within the spirit and scope of the present invention as defined by the appended claims.

What is claimed is:

1. A method of identifying gestures on a touchpad comprising:
determining a first time interval between receipt and drop in a first contact signal induced by a first contact with the touchpad;
recording a first start touch point and a first end touch point associated with the receipt and drop in the first contact signal;
determining a gesture according to the first time interval, the first start touch point and the first end touch point; and
generating a control signal associated with the determined gesture.

2. The method of claim 1, further comprises:
determining a first displacement between the first start touch point and the first end touch point associated with the first contact signal;
determining a first reference interval according to the first time interval and the first displacement; and
comparing the first reference interval to a first reference and a second reference, wherein the first reference is less than the second reference, and the first reference and second reference are predefined.

3. The method of claim 2, furthering comprising:
In an instance in which the first reference interval is larger than the first reference and less than the second reference, outputting a single click signal in the absence of receiving a second contact signal induced by a second contact with the touchpad.

4. The method of claim 2, furthering comprising:
receiving a second contact signal induced by a second contact with the touchpad; and
recording a second time interval between the drop in the first contact signal and receipt of the second contact signal.

5. The method of claim 4, furthering comprising:
determining a second displacement between a second start touch point associated with the second contact signal and the first end touch point associated with the first contact signal;
determining a second reference interval according to the second time interval and the second displacement; and
comparing the second reference interval to a third reference and a fourth reference, wherein the third reference is less than the fourth reference, and the third reference and fourth reference are predefined.

6. The method of claim 5, in an instance in which the second reference interval is larger than the third reference and less than the fourth reference, furthering comprising:
determining a third time interval between receipt and drop in the second contact signal;
determining a third displacement between the second start touch point and an second end touch point associated with the second contact signal;
determining a third reference interval according to the third time interval and the third displacement; and
comparing the third reference interval to a fifth reference and a sixth reference, wherein the fifth reference is less than the sixth reference, and the fifth reference and sixth reference are predefined.

7. The method of claim 6, further comprises:
outputting a double click signal in an instance in which the third reference interval is greater than the fifth reference and less than the sixth reference.

8. The method of claim 6, further comprising:
outputting a drag signal in an instance in which the third reference interval is larger than the sixth reference.

9. A touch gesture identifying device of identifying a gesture on a touchpad, comprising:
a touch screen configured to receive a first contact signal induced by a first contact with the touchpad;
an identifying module, configured to
determine a first time interval between receipt and drop in the first contact signal;
record a first start touch point associated with receipt of the first contact signal and a first end touch point associated with drop in the first contact signal; and
determine a gesture according to the first time interval, the first start touch point and the first end touch point; and
a data storage medium, configured to store data output from the touch screen and the identifying module.

10. The device of claim 9, wherein the identifying module is further configured to
determine a first displacement between the first start touch point and the first end touch point associated with the first contact signal;
determine a first reference interval according to the first time interval and the first displacement; and
compare the first reference interval to a first reference and a second reference, wherein the first reference is less than the second reference, and the first reference and second reference are predefined.

11. The device of claim 10, wherein the identifying module is further configured to
output a single click signal in the absence of receiving a second contact signal induced by a second contact with the touchpad in an instance in which the first reference interval is larger than the first reference and less than the second reference,.

12. The device of claim 10, wherein the touch screen is configured to receive a second contact signal induced by a second contact with the touch screen; and wherein the identifying module is further configured to determine a second time interval between the drop in the first contact signal and receipt of the second contact signal.

13. The device of claim 12, the identifying module is further configured to
determine a second displacement between a second start touch point associated with the second contact signal and the first end touch point associated with the first contact signal.

14. The device of claim 13, the identifying module is further configured to
determine a second reference interval according to the second time interval and the second displacement; and
compare the second reference interval to a third reference and a fourth reference, wherein the third reference is less than the fourth reference, and the third reference and fourth reference are predefined

15. The device of claim 14, wherein in an instance in which the second reference interval is larger than the third reference and less than the fourth reference, the identifying module is further configured to
determine a third displacement between the second start touch point and an second end touch point associated with the second received contact signal;
determine a third time interval between receipt and drop in the second received contact signal;
determine a third reference interval according to the third time interval and the third displacement; and
compare the third reference interval to a fifth reference and a sixth reference, wherein the fifth reference is less than the sixth reference, and the fifth reference and sixth reference are predefined.

16. The device of claim 15, wherein the identifying module is further configured to
output a double click signal in an instance in which the third reference interval is greater than the fifth reference and less than the sixth reference.

17. The device of claim 15, wherein the identifying module is further configured to
output a drag signal in an instance in which the third reference interval is larger than the sixth reference.

18. The device of claim 9, wherein the identifying module further comprises a counter, configured to record the time in receipt of a contact signal and in detecting a drop in the received contact signal.

19. The device of claim 9, wherein the identifying module further comprises a sensing module, configured to sense a contact signal induced by a contact with the touchpad.

20. The device of claim 9, wherein the identifying module further comprises a displacement measurement module, configured to record a start touch point and/or an end touch point of a received contact signal.
